(19) United States
(12) Patent Application Publication
(10) Pub. No.: US 2015/0059848 A1
(43) Pub. Date: Mar. 5, 2015

(54) DYE-SENSITIZED SOLAR CELL

(71) Applicant: USHIO DENKI KABUSHIKI KAISHA, Tokyo (JP)

(72) Inventors: Kosuke Yamada, Hyogo (JP); Masaki Nakamura, Shizuoka (JP)

(21) Appl. No.: 14/469,926

(22) Filed: Aug. 27, 2014

(30) Foreign Application Priority Data
Aug. 28, 2013 (JP) 2013-176798
Aug. 11, 2014 (JP) 2014-163345

(51) Int. Cl. H01G 9/20

(52) U.S. Cl. CPC H01G 9/209; H01G 9/2031; H01G 9/2077
USPC 136/256

(57) ABSTRACT

Provided is a dye-sensitized solar cell that includes: a light-transmissive tubular container; a collector electrode provided on an inner surface of the tubular container, the collector electrode being a transparent conductive film, in which the collector electrode has first electric conductivity; a photoelectrode provided on an inner surface side of the collector electrode, the photoelectrode being a semiconductor layer that supports a sensitizing dye; a counter electrode opposed to the photoelectrode; an electrolytic solution filled inside the tubular container; and a strip conducting section provided on one of the inner surface and an outer surface of the collector electrode, and extending in an axial direction of the tubular container. The strip conducting section has a second electric conductivity that greater than the first electric conductivity.

### CROSS REFERENCE TO RELATED APPLICATIONS

This application claims the benefit of Japanese Priority Patent Application Nos. 2013-176798 filed on Aug. 28, 2013 and 2014-163345 filed on Aug. 11, 2014, the entire contents of which are incorporated herein by reference.

### BACKGROUND

The invention relates to a dye-sensitized solar cell that converts light energy into electric energy. In particular, the invention relates to a dye-sensitized solar cell in which a collector electrode, a photoelectrode, and a counter electrode are disposed in a light-transmissive tubular container and an electrolytic solution is enclosed therein.

A solar cell, which converts sunlight energy into electric energy, has been researched and developed actively due to its advantage as an environmentally-friendly, clean energy source. Among many solar cells, a dye-sensitized solar cell attracts attention as a solar cell that is high in photoelectric conversion efficiency and low in cost, and various proposals have been thus made therefor (for example, see Japanese Patent No. 4840540 (JP4840540B)).

### SUMMARY

A dye-sensitized solar cell disclosed in JP4840540B of a related art is provided with a light-transmissive tubular container, a collector electrode, a photoelectrode, and a counter electrode. The tubular container includes an electrolytic solution enclosed therein. The collector electrode is configured of a transparent electrode film formed on an inner surface of the tubular container. The photoelectrode is configured of a porous semiconductor laminated on the collector electrode and in which a dye is absorbed. The counter electrode is in opposition to the photoelectrode. The dye-sensitized solar cell allows sunlight to enter the photoelectrode and causes excitation of the entered sunlight by the photoelectrode to release electrons, and thereby draws the sunlight therefrom in a form of electric energy.

FIG. 8 illustrates a schematic structure of the dye-sensitized solar cell of a related art according to JP4840540B. Referring to FIG. 8, the dye-sensitized solar cell includes a transparent tubular container 20, a collector electrode 24, and a photoelectrode 25. The tubular container 20 has a main body 21, and is made of a glass. The collector electrode 24 is configured of a transparent conductive film. The photoelectrode 25 is configured of a semiconductor layer in which a sensitizing dye is absorbed. The collector electrode 24 and the photoelectrode 25 are stacked on an inner surface of the main body 21. Further, the dye-sensitized solar cell includes a coil-shaped counter electrode 26 and an electrolytic solution 27. The counter electrode 26 is so disposed inside the tubular container 20 as to be separated away from the photoelectrode 25 and provide a predetermined gap between the photoelectrode 25 and the counter electrode 26. The electrolytic solution 27 includes an electrolyte substance, and is sealed inside the tubular container 20.

The main body 21 of the tubular container 20 has both ends that are hermetically-closed by respective sealing sections 22 and 23. Each of the sealing sections 22 and 23 is flattened, and is formed by heating and melting the glass structuring the tubular container 20 and applying pressure to the melted glass. The sealing section 22 at one end of the tubular container 20 includes a metal foil 33 embedded therein, and an internal lead 31 derived from the counter electrode 26 and an external lead 35 protruding from the sealing section 22 to the outside are each connected to the metal foil 33 to bring portions from the counter electrode 26 to the external lead 35 into electric conduction.

Likewise, a metal foil 34 is embedded in the sealing section 23 provided at the other end of the tubular container 20, and an internal lead 32 connected to the counter electrode 26 through an insulating member 28 and an external lead 36 protruding from the sealing section 23 to the outside are each connected to the metal foil 34. Further, the collector electrode 24 formed on the inner surface of the main body 21 of the tubular container 20 extends to the inside of the sealing section 23, and is so pinch-sealed as to cover the internal lead 32, the metal foil 34, and the external lead 36, to thereby electrically connect the collector electrode 24 and the internal lead 32 as well as the metal foil 34 and the external lead 36.

The sunlight is transmitted through the tubular container 20 of the dye-sensitized solar cell, and is then transmitted through the collector electrode 24, or the transparent conductive film, to reach the photoelectrode 25. Upon reception of the light by the photoelectrode 25, the dye supported by the photoelectrode 25 is excited to generate electrons that migrate to the semiconductor, thereby causing generation of power.

The electrons generated at the photoelectrode 25 are collected at the collector electrode 24, and are drawn to the outside through the collector electrode 24. Hence, high electric resistance of the collector electrode 24 affects an efficiency of drawing the electrons to the outside, which in turn decreases an efficiency of power generation.

A transparent conductive film made of ITO (Indium Tin Oxide) is often used for the collector electrode. The ITO conductive film, however, is also high in electric resistance, and an alternative transparent conductive film having high heat resistance, such as an FTO (Fluorine-doped Tin Oxide) conductive film, a ZnO (zinc oxide) conductive film, or an AZO (Aluminum-doped Zinc Oxide) conductive film, has even higher resistance, leading to a poor efficiency of power generation.

It is desirable to provide a dye-sensitized solar cell capable of efficiently drawing electrons collected at a collector electrode to the outside and thereby increasing efficiency of power generation.

A dye-sensitized solar cell according to an embodiment of the invention includes: a light-transmissive tubular container; a collector electrode provided on an inner surface of the tubular container, and configured of a transparent conductive film, in which the collector electrode has first electric conductivity; a photoelectrode provided on inner surface side of the collector electrode, and configured of a semiconductor layer that supports a sensitizing dye; a counter electrode opposed to the photoelectrode; an electrolytic solution filled inside the tubular container; and a strip conducting section provided on one of an inner surface and an outer surface of the collector electrode, and extending in an axial direction of the tubular container. The strip conducting section has second electric conductivity greater than the first electric conductivity of the collector electrode.

Advantageously, the dye-sensitized solar cell may further include a plurality of linear conducting sections each having third electric conductivity greater than the first electric conductivity of the collector electrode and extending in a circumferential direction of the tubular container. The linear conducting sections may be arrayed in the axial direction of the tubular container, and may each be connected to the strip conducting section.

Advantageously, the strip conducting section may be provided on opposite side of a light-receiving surface in a cross section orthogonal to the axial direction of the tubular container. The light-receiving surface may be a surface at which the tubular container receives sunlight.

Advantageously, the strip conducting section may have a width that is smaller than a width of the counter electrode.

Advantageously, the collector electrode may be the sintered transparent conductive film made of a metal oxide.

Advantageously, the strip conducting section may contain an electroconductive component in which silver is added with one or more elements selected from the group consisting of palladium, iridium, platinum, ruthenium, titanium, copper, and cobalt.

According to the dye-sensitized solar cell in any of the above-described embodiments of the invention, the strip conducting section having the electric conductivity greater than the electric conductivity of the collector electrode is provided on the surface of the collector electrode, making it possible to promptly collect electrons generated at the collector electrode at the strip conducting section. Hence, it is possible to efficiently draw those electrodes to the outside, and thereby to increase efficiency of power generation.

In one embodiment where the dye-sensitized solar cell includes the plurality of linear conducting sections that extend in the circumferential direction, it is possible to finely collect the electrons.

In one embodiment where the strip conducting section is provided on the opposite side of the light-receiving surface for the sunlight, it is possible to allow the sunlight received by the tubular container to reach the light-receiving surface without blocking the sunlight by the strip conducting section, and thereby to prevent a decrease in light-receiving efficiency.

In one embodiment where the strip conducting section has the width that is smaller than the width of the counter electrode, it is possible to allow the sunlight that enters the dye-sensitized solar cell to be transmitted without blocking the sunlight more than necessary.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the disclosure, and are incorporated in and constitute a part of this specification.

The drawings illustrate embodiments and, together with the specification, serve to explain the principles of the invention.

FIG. 1 is a cross-sectional view illustrating a cross section taken along a longitudinal direction of a dye-sensitized solar cell according to an embodiment of the invention.

FIG. 2 is a cross-sectional view illustrating a cross section orthogonal to the longitudinal direction of the dye-sensitized solar cell illustrated in FIG. 1.

FIG. 3 is a development view illustrating a configuration of part of the dye-sensitized solar cell illustrated in FIG. 1 in an unfolded manner.

FIG. 4 is a development view illustrating a configuration of part of the dye-sensitized solar cell illustrated in FIG. 1 in an unfolded manner, according to a first modification example.

FIG. 5 is a development view illustrating a configuration of part of the dye-sensitized solar cell illustrated in FIG. 1 in an unfolded manner, according to a second modification example.

FIG. 6 is a cross-sectional view illustrating a cross section orthogonal to a longitudinal direction of a dye-sensitized solar cell according to another embodiment different from that illustrated in FIG. 1 of the invention.

FIG. 7 is a development view illustrating a configuration of part of the dye-sensitized solar cell illustrated in FIG. 6 in an unfolded manner.

FIG. 8 is a cross-sectional view illustrating a cross section taken along a longitudinal direction of a dye-sensitized solar cell of a related art according to JP4840540B.

### DETAILED DESCRIPTION

Some embodiments of the invention are described in detail below with reference to the accompanying drawings.

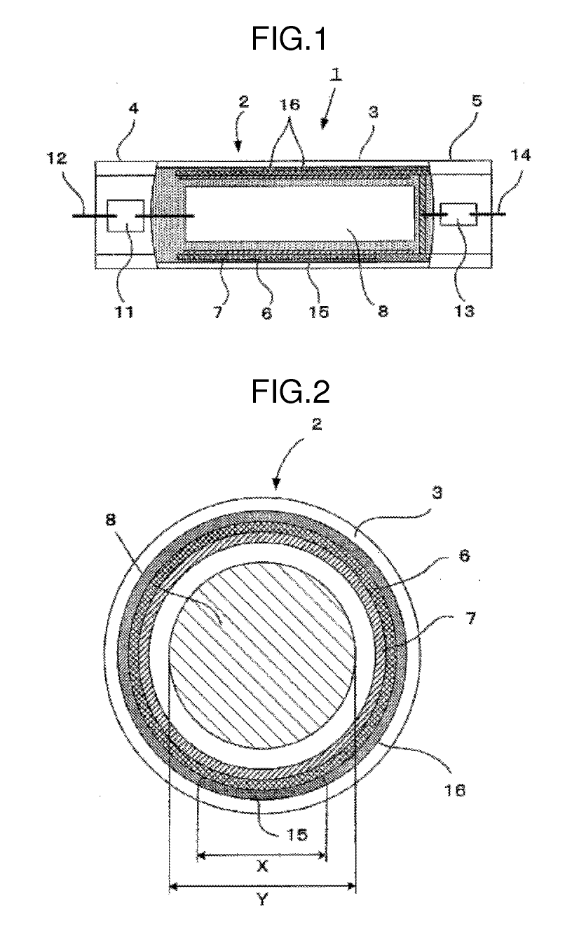

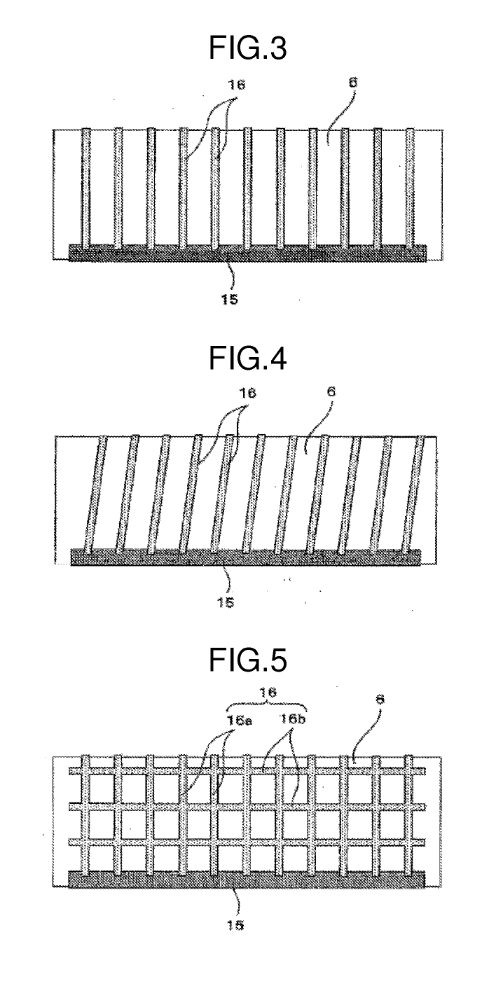

FIGS. 1 and 2 each illustrate an overall configuration of a dye-sensitized solar cell 1 according to an embodiment of the invention. FIG. 3 illustrates a configuration of part of the dye-sensitized solar cell 1 in an unfolded manner.

The dye-sensitized solar cell 1 is provided with a transparent tubular container 2. The tubular container 2 may be made of a material such as vitreous silica or soda glass. The tubular container 2 includes a main body 3 which may have a cylindrical shape, and sealing sections 4 and 5 that serve to seal both ends of the main body 3.

An inner surface of the main body 3 of the tubular container 2 is formed with a collector electrode 6. The collector electrode 6 may be formed through sintering of a transparent conductive film that may be made of a metal oxide such as, but not limited to, ITO, FTO, ZnO, or AZO.

An inner surface of the collector electrode 6 is formed with a photoelectrode 7 stacked thereon. The photoelectrode 7 is configured of a semiconductor layer in which a sensitizing dye is absorbed, and serves to perform photoelectric conversion of sunlight. The semiconductor layer may be a porous thin-film formed through deposition of semiconductor particles which may be, for example but not limited to, a metal oxide or a metal sulfide.

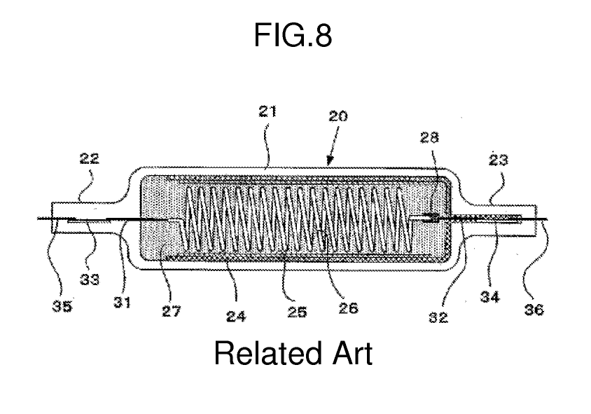

Inside the tubular container 2 is a counter electrode 8 that is in opposition to the collector electrode 6 and the photoelectrode 7. The counter electrode 8 is so disposed inside the tubular container 2 as to be separated away from the collector electrode 6 and the photoelectrode 7 and maintain insulation between the counter electrode 8 and the collector electrode 6 as well as between the counter electrode 8 and the photoelectrode 7. The counter electrode 8 can take various forms, some examples of which may include a cylindrical shaped counter electrode and a coiled counter electrode such as that illustrated in FIG. 8, besides a columnar counter electrode illustrated in FIGS. 1 and 2.

The sealing sections 4 and 5 provided at the both ends of the tubular container 2 may seal the respective ends thereof through melting both ends of a glass which may structure the tubular container 2 to deform those both ends. For example, the sealing sections 4 and 5 may be formed through moderately heating the both ends of the tubular container 2 with the use of a heating device such as a burner to melt and soften part of each of those ends, followed by application of pressure onto the softened parts from upper and lower sides thereof. The pressurized sealing sections 4 and 5 are each formed into a flattened shape.

As illustrated in FIG. 1, a first end of an external lead 12, whose second end is connected to the counter electrode 8 through a metal foil 11, is lead to the outside in the sealing section 4 serving as one of the sealing sections of the tubular container 2, whereas a first end of an external lead 14, whose second end is connected to the collector electrode 6 through a metal foil 13, is lead to the outside in the sealing section 5 serving as the other of the sealing sections of the tubular container 2.

Referring to FIGS. 2 and 3, an outer surface of the collector electrode 6 is provided with a strip conducting section 15 that extends in an axial direction of the tubular container 2 (i.e., a longitudinal direction, or a direction connecting the sealing sections 4 and 5 together, of the tubular container 2). In other words, the strip conducting section 15 is provided between the inner surface of the main body 3 of the tubular container 2 and the outer surface of the collector electrode 6. The strip conducting section 15 is made of a material having electric conductivity greater than that of a material structuring the collector electrode 6.

The strip conducting section 15 may be formed through coating a paste material, which may contain materials such as, but not limited to, an electroconductive component, a glass frit, and a resin binder, onto the inner surface of the main body 3 of the tubular container 2 by a method such as, but not limited to, an ink jet printing or a screen printing, followed by sintering of the coated paste material.

Alternatively, the strip conducting section 15 may be selectively formed through a method such as, but not limited to, evaporation, sputtering, plating, or splay coating, with the use of a mask.

The electroconductive component that may structure the strip conducting section 15 may be a component in which silver (Ag) serving as a main component is selectively added with a metal that serves to adjust the electric conductivity. The metal may be selected from any or any combination of elements such as, but not limited to, palladium (Pd), iridium (Ir), platinum (Pt), ruthenium (Ru), titanium (Ti), copper (Cu), and cobalt (Co).

The strip conducting section 15 may be provided at a downside position that is on the opposite side of a position (an upside position in one embodiment illustrated in FIG. 2) at which the tubular container 2 receives the sunlight.

Such a configuration allows the sunlight to reach the photoelectrode 7 without being blocked by the strip conducting section 15. In other words, if the strip conducting section 15 was located at the position irradiated with the sunlight in the tubular container 2 (the upside position in one embodiment illustrated in FIG. 2), the sunlight to be impinged on the photoelectrode 7, located on the inner side of such a strip conducting section 15, would be blocked by that strip conducting section 15. Hence, providing the strip conducting section 15 at the downside position of the tubular container 2 in one embodiment as described above makes it possible to prevent such circumstances.

Also, the strip conducting section 15 may have a width X that is smaller than a width (diameter) Y of the counter electrode 8. The sunlight may be blocked by the strip conducting section 15 depending on a configuration of the counter electrode 8. Hence, making the width X of the strip conducting section 15 to be smaller than the width Y of the counter electrode 8 makes it possible to prevent the strip conducting section 15 from blocking the sunlight transmitted through the dye-sensitized solar cell 1 as much as, or more than, an amount of light blocked by the counter electrode 8 due to its width Y.

The strip conducting section 15 may be connected with a plurality of linear conducting sections 16. The linear conducting sections 16 extend in a circumferential direction and are connected at any interval to the strip conducting section 15, and are arrayed in the axial direction of the tubular container 2 at a predetermined interval. Each of the linear conducting sections 16 may have a width that is smaller than the width X of the strip conducting section 15, for example. Factors such as the width of each of the linear conducting sections 16 and the number of the linear conducting sections 16 may be so determined as to prevent transmission of the sunlight from being hindered more than necessary.

It is to be noted that the linear conducting sections 16 are not limited to the configuration in which the linear conducting sections 16 extend in the circumferential direction as illustrated in FIG. 3. In one embodiment, the linear conducting sections 16 may be helically provided as illustrated in FIG. 4, or may have a configuration that includes circumferential parts 16a and axial parts 16b as illustrated in FIG. 5. The circumferential parts 16a each extend in the circumferential direction, and the axial parts 16b each extend in a direction orthogonal to the circumferential direction (i.e., the axial direction of the tubular container 2). Alternatively, in one embodiment, the linear conducting sections 16 may be provided partially in the circumferential direction, without being entirely provided all around in the circumferential direction.

The linear conducting sections 16 each may be made of a material having electric conductivity greater than the electric conductivity of the collector electrode 6 as with the strip conducting section 15. In one embodiment, each of the linear conducting sections 16 may be made of the same material as the strip conducting section 15.

The strip conducting section 15 and the linear conducting sections 16 thus provided on the inner surface of the tubular container 2 are formed with the collector electrode 6 which may be stacked thereon (on inner surfaces of the strip conducting section 15 and the linear conducting sections 16) through coating and sintering of the transparent conductive film that may be made of the metal oxide as described above. In other words, in this configuration, the strip conducting section 15 and the linear conducting sections 16 are provided on outer surface side of the collector electrode 6.

In the example embodiment described above, the strip conducting section 15 and the linear conducting sections 16 are provided on the outer surface side of the collector electrode 6, i.e., between the outer surface of the collector electrode 6 and the inner surface of the tubular container 2. Alternatively, in one embodiment, the strip conducting section 15 and the linear conducting sections 16 may be provided on inner surface side of the collector electrode 6.

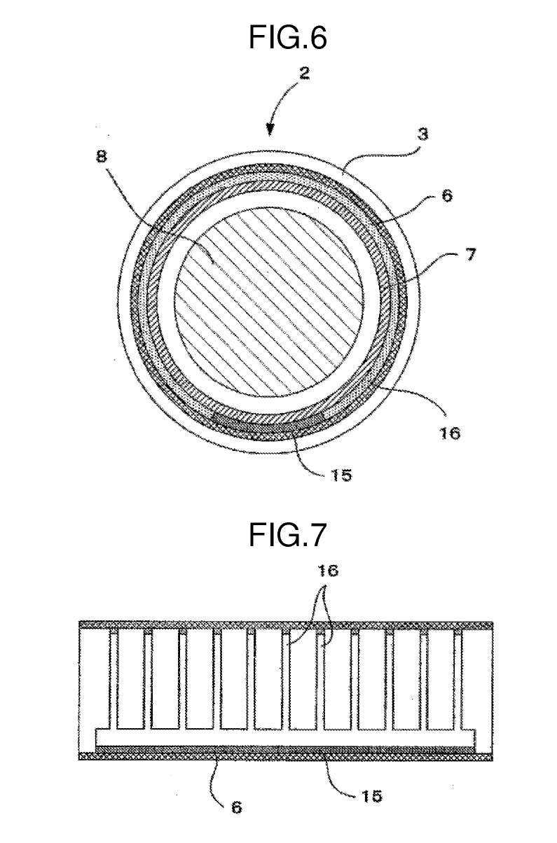

FIGS. 6 and 7 each illustrate one embodiment where the strip conducting section 15 and the linear conducting sections 16 are provided on the inner surface side of the collector electrode 6. In this embodiment, the strip conducting section 15 and the linear conducting sections 16 are each formed through coating and sintering on the inner surface of the collector electrode 6 provided on the inner surface of the main body 3 of the tubular container 2, and the photoelectrode 7 is further provided on the inner surfaces of the strip conducting section 15 and the linear conducting sections 16.

In the above-described example embodiment, the strip conducting section 15 and the linear conducting sections 16 are provided on one of the surfaces (the inner surface or the outer surface) of the collector electrode 6. Hence, the electrons collected at the collector electrode 6 are collected immediately at the strip conducting section 15 through the linear conducting sections 16 provided in the vicinity of the collector electrode 6, following which the electrons thus collected at the strip conducting section 15 are drawn to the outside through the strip conducting section 15.

It is to be noted that the linear conducting sections 16 may be provided on an optional basis. In other words, when a configuration provided with the strip conducting section 15 without the linear conducting sections 16 achieves satisfactory effects, e.g., when the electrons collected at the collector electrode 6 are able to be released to the outside efficiently enough, the linear conducting sections 16 may be omitted in one embodiment.

The following shows one numerical example of a dye-sensitized solar cell according to an embodiment of the invention.

Dimensions of tubular container:

a. 10 mm (outer diameter)*8 mm (inner diameter)*1 mm (thickness)

Thickness of collector electrode: 1 μm

Thickness of photoelectrode: 10 μm

Strip conducting section: 1 μm in thickness and 2 mm to 3 mm in width

Linear conducting section: 1 μm in thickness and 0.1 mm to 1 mm in width

In the dye-sensitized solar cell according to any of the example embodiments of the invention as described above, the strip conducting section extending in the axial direction of the tubular container is provided on one of the surfaces of the collector electrode provided on the inner surface of the tubular container. The strip conducting section is made of the material having the electric conductivity greater than the electric conductivity of the collector electrode. This makes it possible to guide the electrons, collected at the collector electrode from the photoelectrode, to the strip conducting section promptly and efficiently. Hence, it is possible to draw those collected electrons to the outside through the strip conducting section, and thereby to increase efficiency of power generation.

Further, in one embodiment where the linear conducting sections are provided that extend in the circumferential direction and that are connected to the strip conducting section, it is possible to guide the electrons at the collector electrode to the strip conducting section finely and promptly with reduced loss. Hence, it is possible to achieve further increase in the efficiency of power generation.

Furthermore, the invention encompasses any possible combination of some or all of the various embodiments described herein and incorporated herein.

It is possible to achieve at least the following configurations from the above-described example embodiments of the invention.

A dye-sensitized solar cell, including:

a light-transmissive tubular container;

a collector electrode provided on an inner surface of the tubular container, and configured of a transparent conductive film, the collector electrode having first electric conductivity;

a photoelectrode provided on inner surface side of the collector electrode, and

configured of a semiconductor layer that supports a sensitizing dye;

a counter electrode opposed to the photoelectrode;

an electrolytic solution filled inside the tubular container; and

a strip conducting section provided on one of an inner surface and an outer surface of the collector electrode, and extending in an axial direction of the tubular container, the strip conducting section having second electric conductivity greater than the first electric conductivity of the collector electrode.

(2) The dye-sensitized solar cell according to (1), further including a plurality of linear conducting sections each having third electric conductivity greater than the first electric conductivity of the collector electrode and extending in a circumferential direction of the tubular container, the linear conducting sections being arrayed in the axial direction of the tubular container, and each being connected to the strip conducting section.

(3) The dye-sensitized solar cell according to (1) or (2), wherein the strip conducting section is provided on opposite side of a light-receiving surface in a cross section orthogonal to the axial direction of the tubular container, the light-receiving surface being a surface at which the tubular container receives sunlight.

(4) The dye-sensitized solar cell according to (3), wherein the strip conducting section has a width that is smaller than a width of the counter electrode.

(5) The dye-sensitized solar cell according to any one of (1) to (4), wherein the collector electrode is the sintered transparent conductive film made of a metal oxide.

(6) The dye-sensitized solar cell according to any one of (1) to (5), wherein the strip conducting section contains an electroconductive component in which silver is added with one or more elements selected from the group consisting of palladium, iridium, platinum, ruthenium, titanium, copper, and cobalt.

Although the invention has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. A dye-sensitized solar cell, comprising:
a light-transmissive tubular container;
a collector electrode provided on an inner surface of the tubular container, and the collector electrode being a transparent conductive film, the collector electrode having a first electric conductivity;
a photoelectrode provided on an inner surface side of the collector electrode, the photoelectrode being a semiconductor layer that supports a sensitizing dye;
a counter electrode opposed to the photoelectrode;
an electrolytic solution filled inside the tubular container; and
a strip conducting section provided on one of the inner surface and an outer surface of the collector electrode, and extending in an axial direction of the tubular container, the strip conducting section having a second electric conductivity that is greater than the first electric conductivity.

2. The dye-sensitized solar cell according to claim 1, further comprising linear conducting sections each having a third electric conductivity that is greater than the first electric conductivity and extending in a circumferential direction of the tubular container, the linear conducting sections being arrayed in the axial direction of the tubular container, and each being connected to the strip conducting section.

3. The dye-sensitized solar cell according to claim 1, wherein the strip conducting section is provided on opposite side of a light-receiving surface in a cross section orthogonal to the axial direction of the tubular container, the light-receiving surface being a surface at which the tubular container receives sunlight.

4. The dye-sensitized solar cell according to claim 3, wherein the strip conducting section has a width that is smaller than a width of the counter electrode.

5. The dye-sensitized solar cell according to claim 1, wherein the collector electrode is the sintered transparent conductive film made of a metal oxide.

6. The dye-sensitized solar cell according to claim 1, wherein the strip conducting section contains an electroconductive component in which silver is added with one or more elements selected from the group consisting of palladium, iridium, platinum, ruthenium, titanium, copper, and cobalt.
